(19) United States
(12) Patent Application Publication
(10) Pub. No.: US 2004/0075790 A1
(43) Pub. Date: Apr. 22, 2004

(54) Pellucid LCD and fabrication method of same

(75) Inventor: Po-Hsien Wang, Taichung (TW)

Correspondence Address: TROXELL LAW OFFICE PLLC, 5205 LEESBURG PIKE, SUITE 1404, FALLS CHURCH, VA, 22041, US

(73) Assignee: Wintek Corporation

(21) Appl. No.: 10/274,204

(22) Filed: Oct. 21, 2002

(51) Int. Cl. G02F 1/1335

(52) U.S. Cl. 349/113

(57) ABSTRACT

The performance of a pellucid LCD is marvelously improved by staggeringly disposing the transparent electrodes and the metallic electrodes in the display zone so as to serve functions of light transmission and light reflection respectively. Besides the two electrodes are isolated by a transparent dielectric layer such that the distance between adjacent electrodes (pixels) can be shortened to overcome the fabrication and masking difficulty. Electrodes formed of thin metallic conducting films contribute to narrowing the scanning line thereby a narrower dummy display edge can be realized.

### BACKGROUND OF THE INVENTION

1. Field of the invention

The present invention relates to a pellucid LCD (liquid crystal display), in particular, to a pellucid LCD characterized in having excellent properties of high metallic reflectivity and low resistivity, and by overcoming the adjacent pixel distance limit as that in a conventional LCD so as to effectively improve the aperture rate so as to attain the aim of high light efficiency (brightness) in transmission and reflection, low power consumption and low cross talk. The invention also discloses fabrication method of same.

2. Description of the Prior Art

In a convention LCD acquired Taiwan (ROC) Patent NO. 445388 published in Taiwan (ROC) Patent Gazette (called as cited case) shown in FIG. 1, it is essentially characterized in that a glass plate 28 coated with a dielectric substance layer 27 thereon is entrained on a lower substrate 19, and a plurality of silver coated electrodes 21 and protective insulation films are nematically arrayed on the dielectric substance layer 27. With such a structure, this LCD has been designed mainly as a reflective LCD, if it is intended to be a pellucid LCD, the only way is to control the thickness of the protective film on the aluminum electrode which has a reflectivity of about 90%. Besides, another factor influencing the light efficiency, i.e. the aperture rate, is limited by inherent difficulty in the photo-lithography process between the electrodes.

Another conventional LCD disclosed in Taiwan (ROC) Pat. NO. 409261 is shown in FIG. 2. In this cited case, an underlaid layer 1, a lower layer non-crystal oxide electrode 2, a silver reflection electrode 3, and an upper layer non-crystal oxide electrode 4 are formed successively in order on the lower substrate 10. In this design, the non-crystal oxide electrode 2 is used to enclose the silver reflection electrode 3 so as to obtain a reflectivity higher than that formed of aluminum and at the same time, to prevent the possibility of occurrence of interface shift of the silver film. However, it is disadvantageous that the metallic electrode must be entirely enclosed by the non-crystal oxide electrode, Besides, clearance between the electrodes is limited by the yellow light fabrication process resulting in a low aperture rate.

In conclusion, up gradation in of the conventional LCD and its fabrication method is still obstructed by the following factors, namely:

1. Boundary of 92% photo utilization factor for existing pellucid reflection film is unable to break through by present technology.

2. The aim to obtain preferably narrow dummy edged LCD can not be attained by present electrode constructed by a thick transparent film of high resistance resulting in greater than 50 um width electrode strip is required to maintain transparency.

3. The boundary of 80% aperture ratio can not be broken through by existing separation 10 um between adjacent electrodes that obstructs photo-lithography process.

In order to overcome the shortcomings inherent to the conventional technique described above, the present inventor has been endeavoring for a long time intensified research and experimentation to find out the solution and finally has come to realization of the present invention.

### SUMMARY OF THE INVENTION

It is an object of the present invention to provide a pellucid LCD capable of effectively upgrading conductivity of the transparent conducting film so as to shorten the width of the scanning lines.

To achieve this object, the electrode is formed of a metallic reflective part and a transparent film so as to upgrade the conductivity thereby obtaining a narrow dummy edged LCD.

It is another object of the present invention to provide a pellucid LCD capable of attaining 95% photo utilization efficiency at the reflection region, and 100% at the aperture region.

To achieve this object, the electrode is formed of a metallic reflective part and a transparent film for respectively reflecting and transmitting the incident light in proportion to their areas.

It is a further object of the present invention to provide a pellucid LCD capable of improving the aperture ratio in the display zone up to 90% so as to intensify the brightness of the LC>

To achieve this object, the separation distance between adjacent electrodes is increased by specially constructed and arrayed electrodes described below.

The pellucid LCD of the present invention is constructed of an upper substrate and a lower substrate interposing liquid crystal molecules therebetween. On the upper substrate, an alignment film, a transparent conducting film, an upper transparent substrate, and a polarizer are formed stacking up from bottom to top in order. On the lower substrate, a polarizer, a lower transparent substrate, a transparent dielectric layer, a plurality of arrayed metallic electrodes, a transparent insulation layer, a plurality of transparent electrodes, and an alignment film are formed stacking upwards in order. The kernel of the present invention lies in that the width of the scanning line is greatly reduced and the photo utilization is increased by ingeniously cooperated metallic and transparent electrodes. By insertion of an extra dielectric layer, the aperture rate in display zone can be improved overcoming the difficulty for masking and fabrication process that the prior art encounters. The present invention also provides fabrication method of same.

### BRIEF DESCRIPTION OF THE DRAWINGS

The accompanying drawings, which are included to provide a further understanding of the invention and incorporated in and constitute a part of this specification, illustrate the embodiment of the invention and together with the description serve to explain the principles of the invention, wherein:

FIG. 1 is a transverse cross sectional view of a conventional LCD;

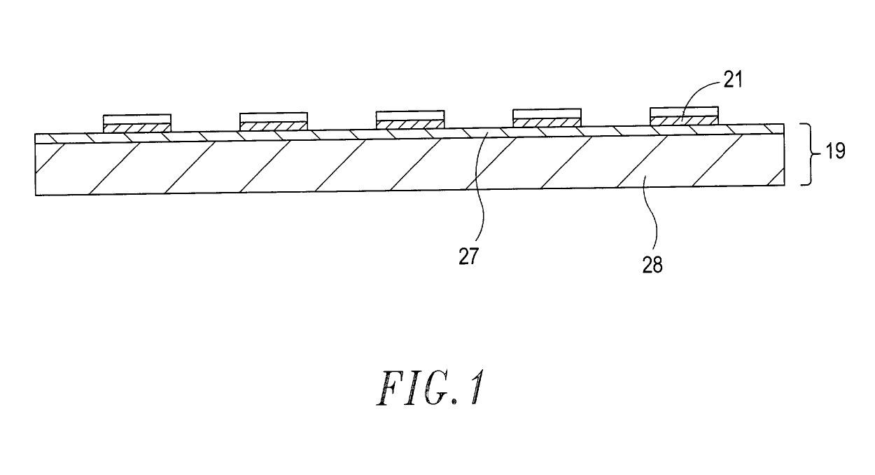

FIG. 2 is a transverse cross sectional view of another conventional LCD;

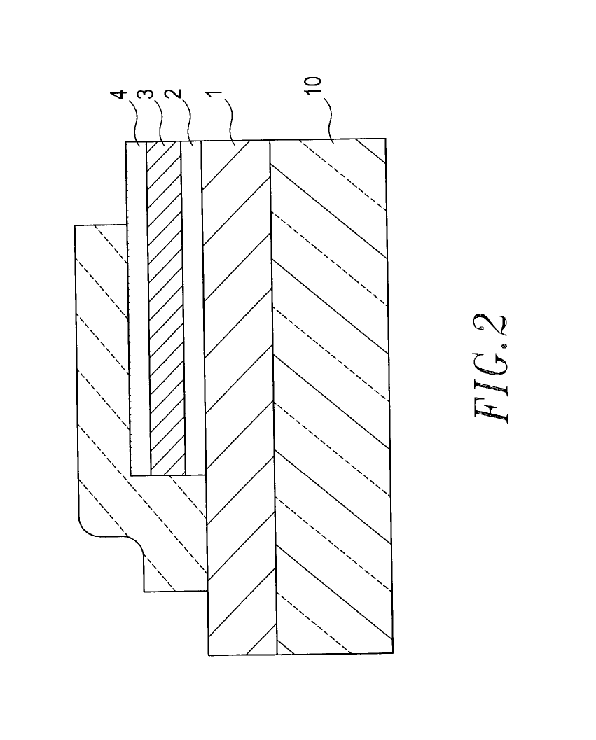

FIG. 3 is a cross sectional view of the pellucid LCD according to the present invention;

FIG. 4 is a top view of the lower substrate of the pellucid LCD according to the present invention;

FIG. 5 is a cross sectional view for illustrating structure in the lower substrate display zone of the pellucid LCD according to the present invention;

FIG. 6 is a cross sectional view for illustrating structure outside of the lower substrate display zone of the pellucid LCD according to the present invention.

### DETAILED DESCRIPTION OF THE PREFERRED EMBODIMENT

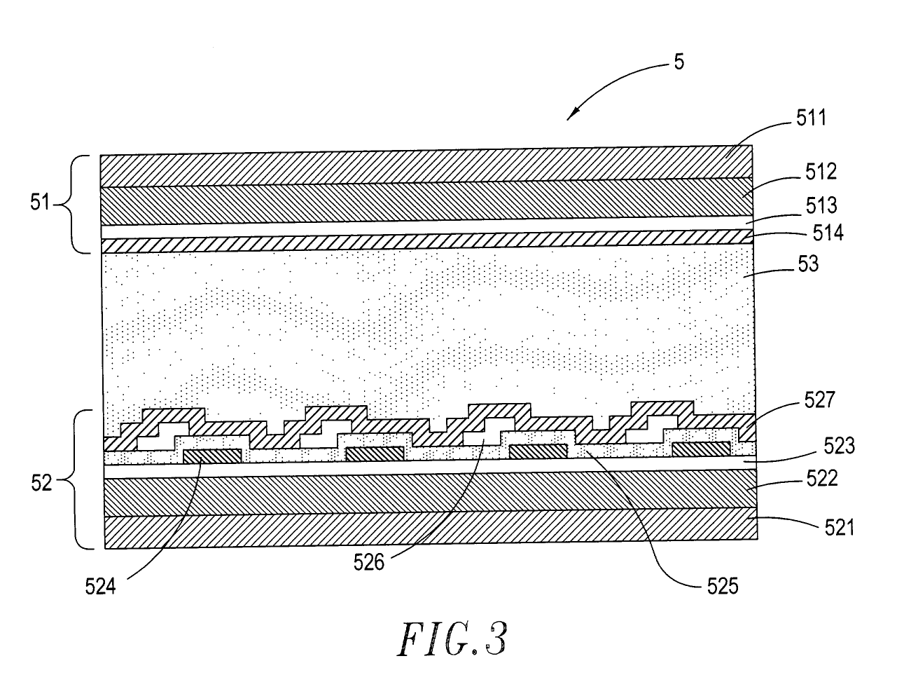

Referring to FIG. 3 which shows a cross sectional view of the pellucid LCD according to the present invention, the pellucid LCD 5 comprises an upper substrate 51 and a lower substrate 52 interposing numerous liquid crystal molecules 53 therebetween. On the upper substrate 51, an alignment film 514, a transparent conducting film 513, an upper transparent substrate 512, and a polarizer 511 are formed stacking up on top of each other in order. On the lower substrate 52, another polarizer 521, a lower transparent substrate 522, a transparent dielectric layer 523, a plurality of arrayed metallic electrodes 524, a transparent insulation layer 525, a plurality of transparent electrodes 526, and an alignment film 527 are formed stacking up on top of each other in order. A metal reflection layer is at first patterned by yellow light process, the display zone in the patterned area has both light reflection and electric conducting properties, while the non-display zone thereof has only an electric conducting property. As shown in FIG. 3, in the display zone, the transparent electrodes 526 and the metallic electrodes 524 are staggeringly disposed so as to serve functions of light transmission and light reflection respectively. Besides, in the display zone, the aforementioned electrodes 526 and 524 are isolated by the transparent dielectric layer 525. The configuration of the transparent insulation layer is defined by a shadow mask. In the non-display zone, the electrodes 526 and 524 directly contact with each other by overlapping. Each corresponding pair of electrodes 526 and 524 are connected with each other at both terminals in the display zone so as to maintain necessary potential and avoid power interruption thereby assuring the LCD quality.

Meanwhile, the fabrication method for the pellucid LCD of the present invention comprises the steps:

step 1: forming the dielectric layer on the transparent substrate by sputtering using TiO2 or SiO2, the layer thickness being less than 700 Å;

step 2: forming a metallic film at first by sputtering silver or alminum alloy on the dielectric layer, the film being thicker than 200 Å, and then employing the yellow light process to define the metallic film as the metallic electrode;

step 3: coating one or more than one transparent insulation layer on the metallic electrode in the display zone, the layer thickness being greater than 200 Å;

step 4: at first forming a transparent conducting film on the metallic electrode by sputtering ITO, the film thickness being greater than 500 Å, while the resistance being less than 80 Ω/□, and then defining this transparent conducting film as the transparent electrode by yellow light process thus completing fabrication of the electrode on the lower substrate;

step 5: at first forming a transparent conducting film on the upper transparent substrate by sputtering ITO, the film thickness being greater than 300 Å, while the resistance being less than 80 Ω/□, and then defining this transparent conducting film as the transparent electrode by yellow light process thus completing fabrication of the electrode on the upper substrate;

step 6: forming the upper and the lower nematic films by coating an alignment liquid on the upper and lower substrates, and cleaning the surfaces of the nematic films with a brush tenderly;

step 7: coupling the upper and the lower substrates together and facing the electrodes on each substrate against each other, and interposing LC molecules between the two substrates, the phase difference Δnd of the LC molecules being in the range of 700 nm˜900 nm;

step 8: attaching the polarizers on the top and bottom surfaces of the assembled LCD respectively thereby completing the fabrication of the pellucid LCD of the present invention.

Procedures of coating photo resistive substance, exposing, developing, itching, and lifting off are included in the above mentioned yellow light process.

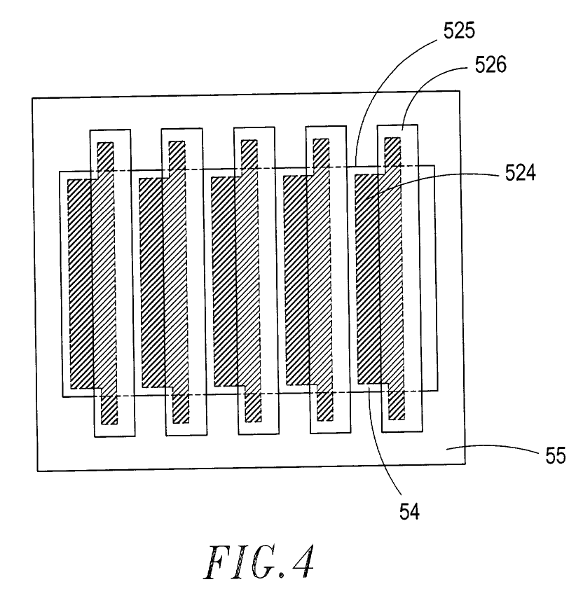

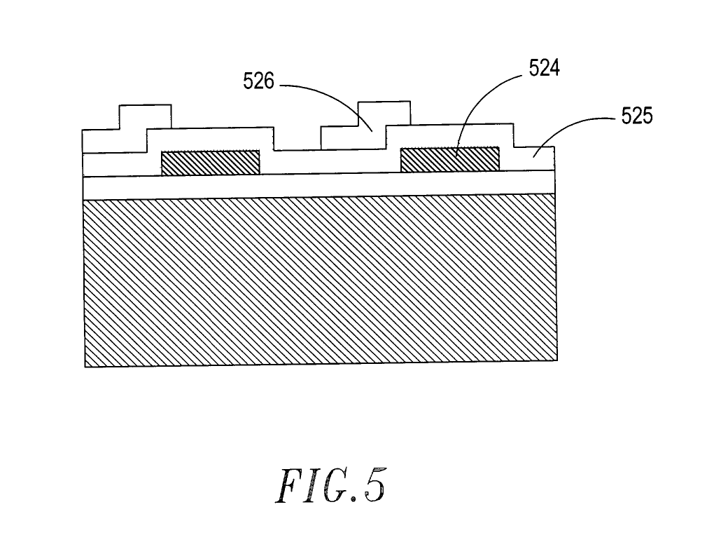

FIGS. 4 and 5 are a top view of the lower substrate and a cross sectional view for illustrating structure in the lower substrate display zone respectively. As shown in the two drawings, in the display zone 54, the transparent electrodes 526 and the metallic electrodes 524 are staggeringly disposed so as to serve functions of light transmission and light reflection respectively. Comparing with a metallic pellucid film, such an arrangement is advantageous for improving the photo efficiency. Besides, in the display zone 54, the electrodes 526 and 524 are isolated by the transparent insolation layer 525 such that the distance between adjacent electrodes (pixels) can be shortened to overcome the restriction of fabrication process and difficulty in masking without the fear of short circuiting. Meanwhile the configuration of this layer 525 is defined by a shadow mask in the display zone 54.

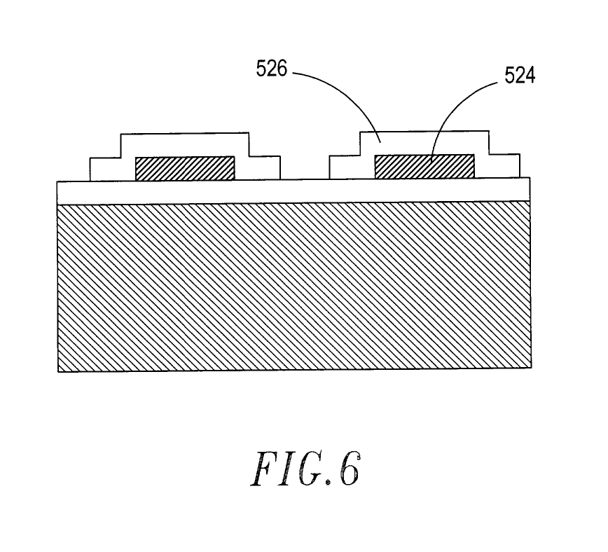

Referring simultaneously to FIGS. 4 and 6, the two drawings show a top view of the lower substrate and a cross sectional view illustrating structure outside of the lower substrate display zone respectively. As it can be observed on the drawings, in the non-display zone 55, the electrodes 526 and 524 directly contact with each other in overlapping stage. Each corresponding pair of both electrodes 526 and 524 are connected together at two terminals in the display zone 54 so as to maintain necessary potential thereat.

The color STN display terminal for the new generation cellular phone calls for a narrow dummy display edge so as to minimize the screen size. On the other hand, overall photo efficiency shall be improved. Under this condition, the design aspect that the metallic reflection layer incorporated with a transparent electrode in the present invention can significantly achieve the object of improving the photo efficiency of a LCD. In addition to this, the insertion of an extra dielectric layer contributes to enlarging the aperture rate which has been considered impossible by conventional techniques.

Here, let us touch on briefly several noteworthy prominent feactures of the present invention as follows:

1. The photo efficiency is upgraded so high that it shows up to 95% at the reflection zone, and almost up to 100% at the aperture zone.

2. Thin metallic conducting film leads to lowering its resistance and narrowing the scanning line thereby a narrower dummy display screen edge can be realized.

3. The aperture rate can be enlaged up to about 90%.

4. The yield of fabrication is improved by increasing the conductance of the transparent conducting film and narrowing the scanning line.

While it will be apparent that the preferred embodiment of the invention disclosed above is well calculated to provide the advantages and features above stated, it will be appreciated that the invention is susceptible to modification, variation and change without departing from the proper scope or fair meaning of the subjoined claims.

What is claimed is:

1. A pellucid LCD comprising an upper substrate and a lower substrate interposing liquid crystal molecules therebetween, wherein;
on said upper substrate, an alignment film, a transparent conducting film, an upper transparent substrate, and a polarizer are formed by stacking on top of each other from bottom to top in order;
on said lower substrate, a polarizer, a lower transparent substrate, a transparent dielectric layer, a plurality of arrayed metallic electrodes, a transparent insulation layer, a plurality of transparent electrodes, and an alignment film are formed stacking up on top of each other upwardly in order; wherein,
a metal refection layer is at first patterned with yellow light process, the display zone in the patterned area has both light reflection and electric conducting properties, while the non-display zone thereof has only an electric conducting property, in the display zone, said transparent electrodes and said metallic electrodes are staggeringly disposed so as to serve functions of light transmission and light reflection respectively, besides, in the display zone, said transparent electrodes and said metallic electrodes are isolated by said transparent dielectric layer, the configuration of said transparent insulation layer is defined by a shadow mask; in the non-display zone, said transparent electrodes and said metallic electrodes are directly contacted with each other in an overlapping state, each corresponding pair of said transparent electrodes and said metallic electrodes are connected with each other at both terminals in the display zone so as to maintain necessary potential for all electrodes.

2. The pellucid LCD of claim 1, wherein one or more than one said transparent dielectric layer is interposed between said metallic electrode and said transparent substrate.

3. The pellucid LCD of claim 1, wherein an electrode unit for the LCD includes one said metallic electrode and one said transparent electrode.

4. The pellucid LCD of claim 2, wherein said transparent dielectric layer is formed of non-organic oxide of Si and Ti.

5. Fabrication method for said pellucid LCD comprising the steps:
step 1: forming said dielectric layer on said transparent substrate by sputtering;
step 2: forming a metallic film at first by sputtering silver or alminum alloy on said dielectric layer, and then employing the yellow light process to define said metallic film as said metallic electrode;
step 3: coating said transparent insulation layer on said metallic electrode in the display zone using one or more than one layer of dielectric substance;
step 4: at first forming a transparent conducting film on said metallic electrode by sputtering, and then defining this transparent conducting film as said transparent electrode by yellow light process thus completing fabrication of the electrode on said lower substrate;
step 5: at first forming a transparent conducting film on said upper transparent substrate by sputtering, and then defining this transparent conducting film as said transparent electrode by yellow light process thus completing fabrication of the electrode on said upper substrate;
step 6: forming said upper and said lower nematic films by coating an alignment liquid on said upper and lower substrates, and cleaning the surfaces of said nematic films with a brush tenderly;
step 7: coupling said upper and said lower substrates together while facing the electrodes on each substrate against each other, and interposing LC molecules between said two substrates; and
step 8: attaching said polarizers on the top and the bottom surfaces of the assembled LCD respectively thereby completing the fabrication of said pellucid LCD.

6. The pellucid LCD of claim 5, wherein said transparent conducting film is formed by vacuum coating process.

7. The pellucid LCD of claim 5, wherein said transparent insulation layer is a thin transparent insulation film formed of one or more than one layer of dielectric or resin film.

8. The pellucid LCD of claim 5, wherein said yellow light process includes procedures of coating photo resistive substance, exposing, developing, etching, and lifting off.

9. The pellucid LCD of claim 5, wherein materials for said dielectric layer in step 1 is TiO2 or SiO2, the film thickness being less than 700 Å.

10. The pellucid LCD of claim 5, wherein the thickness of said silver or alminum alloy film is greater than 200 Å.

11. The pellucid LCD of claim 5, wherein the thickness of said transparent insulation layer is greater than 200 Å.

12 The pellucid LCD of claim 5, wherein the thickness of said ITO transparent conducting film is greater than 300 Å, and the resistance thereof smaller than 80 Ω/□.

13. The pellucid LCD of claim 5, wherein the phase difference Δnd of said liquid crystal molecules is between 700 nm˜900 nm.
